(19) United States
(12) Patent Application Publication
(10) Pub. No.: US 2016/0266250 A1
(43) Pub. Date: Sep. 15, 2016

(54) UNDERWATER NAVIGATION SYSTEM

(71) Applicant: Kraken Sonar Systems Inc., Conception Bay South (CA)

(72) Inventors: Jeremy DILLON, Conception Bay South (CA); David SHEA, Conception Bay South (CA); Karl KENNY, Conception Bay South (CA)

(21) Appl. No.: 15/069,027

(22) Filed: Mar. 14, 2016

Related U.S. Application Data
(60) Provisional application No. 62/132,898, filed on Mar. 13, 2015.

(51) Int. Cl. G01S 15/58; G10K 11/00

(52) U.S. Cl. CPC G01S 15/58; G10K 11/008

(57) ABSTRACT

An underwater navigation system is provided, comprising: a transducer configured to emit a first and second acoustic pulses separated by a predetermined time period; a receiver array comprising a plurality of acoustic receivers each configured to receive first reflected portions of the first acoustic pulses and second reflected portions of the second acoustic pulses; the array including a plurality of neighbouring pairs of acoustic receivers wherein a distance between a first neighbouring pair is different from a distance between a second neighbouring pair; and a processor coupled to the receiver array, and configured to generate a velocity measurement based on the predetermined time period and signals from the receiver array representing the first and second reflected portions.

### CROSS-REFERENCE TO RELATED APPLICATION

This application claims priority from U.S. provisional patent application No. 62/132898, filed Mar. 13, 2016, the contents of which is incorporated herein by reference.

### FIELD

The specification relates in general to underwater navigation, and in particular to an underwater navigation system for generating velocity measurements.

### BACKGROUND

Underwater navigation systems are employed in a diverse range of applications such as subsea surveying, safe operation and recovery of Unmanned Underwater Vehicles (UUVs), swimmer delivery systems, and naval mine hunting and neutralization.

Although GPS and other radio signals have been widely used for surface vessel navigation, these technologies are ineffective for underwater navigation because electromagnetic waves are blocked by seawater. Inertial sensing is a conventional technology for autonomous underwater navigation. However, inertial navigation systems can suffer from position error that tends to drift without bound in the absence of input from an aiding sensor.

In an attempt to overcome the above-mentioned problem of unbounded position error, some systems combine inertial technology with velocity measurements from an acoustic sensor that measures speed from echoes reflected from the seafloor.

Many existing acoustic velocity measurement systems exploit the Doppler principle, which is the frequency shift of the seabed or seawater echoes due to the relative motion of the sonar. A typical Doppler Velocity Log (DVL) system consists of four narrow beams steered in the fore/aft and port/starboard directions to estimate the three-dimensional velocity vector from Doppler shifts associated with each beam. The beams are steered downward approximately 30° from vertical in a compromise between operating near nadir to maximize seabed echo strength while also requiring a non-zero Doppler shift when measuring the horizontal component of velocity.

Some implementations of DVL employ four separate piston transducers to form the four sonar beams. In order to resolve a velocity vector from DVL acoustic transmissions, the angle of the corresponding seabed echoes must be known precisely, which requires the use of narrow beams. This leads to a relatively large sensor with an unavoidable trade-off between size and range. For example, when operating at 300 kHz, each piston must be on the order of 5 to 10 cm in diameter to achieve a beam width of a few degrees. This gives an overall diameter of about 20 cm for a DVL operating at 300 kHz frequency for which the range is approximately 200 m, which is less than that required for operation over many continental shelves. Reducing DVL size without compromising accuracy requires that the operating frequency be increased, which in turn reduces the range of the system due to the increase in sound absorption. At 1200 kHz, the DVL size can in principle be reduced by a factor four compared to 300 kHz, which is desirable for small UUVs. However, the range at 1200 kHz is drastically reduced to only 30 m.

Another limitation of conventional DVL systems is the trade-off between narrowband and wideband signaling techniques. While narrowband transmission allows for a very simple detection of the Doppler frequency shift (e.g. as the centroid of the spectrum of the echo), the lack of range resolution leads to an inability to resolve fine spatial gradients in the current profile as well as increased variance in the velocity estimate. The variance can be reduced by averaging over an ensemble of pings at the price of reduced temporal resolution, but the system is then no longer able to track fast changes in velocity with time. Wideband measurement techniques have been developed to overcome this limitation. However, for wideband DVLs, there is a further decrease in the operational range of the system due to the increased noise bandwidth and the corresponding decrease in signal to noise ratio, which exacerbates the range limitation from acoustic absorption. Thus DVLs are generally offered either in a high resolution short range mode, using wideband pulses, or a low resolution longer range mode, using the more traditional narrowband mode.

A further drawback of the multi-piston DVL is that the Doppler frequency shift depends on the local sound speed, which in turn depends on temperature, depth, and salinity. This requires additional sensors (e.g. a complex conductivity sensor), which adds to the size and cost of the overall navigation package. In the absence of these additional sensors, significant position errors can accumulate due to unaccounted-for variations in sound speed. While a phased array may be used in place of multiple pistons to combat the sound speed dependence, the price to pay is a further increase in complexity and cost, since the phased array must be populated with half-wavelength element spacing in order to form the same narrow beams as the multi-piston head. For example, a matrix on the order of one thousand elements is required to achieve 4° beams, and 16000 channels would be required to further narrow the beams to 1°. Thus, phased array DVLs face a similar trade-off between size and range as encountered with conventional DVLs.

Another acoustic technology for underwater velocity measurement is known as the Correlation Velocity Log (CVL). A CVL transmits pulses vertically downward with a broader beam than used for DVLs. The reflected signal is captured by a plurality of receivers, and the known distance between receivers, as well as the time between pulses, are used to compute velocity. However, conventional CVL technologies also suffer from certain drawbacks. For example, many CVL packages are too large for effective use on some UUVs. Attempts to design smaller CVL packages have generally resulted in reduced accuracy, range, or both.

### SUMMARY

According to an aspect of the specification, an underwater navigation system is provided, comprising: a transducer configured to emit a first and second acoustic pulses separated by a predetermined time period; a receiver array comprising a plurality of acoustic receivers each configured to receive first reflected portions of the first acoustic pulses and second reflected portions of the second acoustic pulses; the array including a plurality of neighbouring pairs of acoustic receivers wherein a distance between a first neighbouring pair is different from a distance between a second neighbouring pair; and a processor coupled to the receiver array, and configured to generate a velocity measurement based on the predetermined time period and signals from the receiver array representing the first and second reflected portions.

### BRIEF DESCRIPTIONS OF THE DRAWINGS

Embodiments are described with reference to the following figures, in which:

FIG. 1 depicts an underwater vehicle, according to a non-limiting embodiment;

FIG. 2 depicts a navigation system of the underwater vehicle of FIG. 1, according to a non-limiting embodiment;

FIGS. 3 and 4 depict the emission and receipt of successive acoustic pulses and reflections by the system of FIG. 2, according to a non-limiting embodiment;

FIG. 5 depicts an array for the system of FIG. 2, according to another non-limiting embodiment;

FIG. 6 depicts displacement vector coverage of the array of FIG. 5, according to a non-limiting embodiment;

FIG. 7A depicts a conventional receiver array;

FIG. 7B depicts displacement vector coverage of the array of FIG. 7A;

FIG. 8 depicts an array for the system of FIG. 2, according to a further non-limiting embodiment;

FIG. 9 depicts displacement vector coverage of the array of FIG. 8, according to a non-limiting embodiment;

FIG. 10 depicts a method of generating velocity measurements, according to a non-limiting embodiment; and

FIG. 11 depicts a deployment of the system of FIG. 2, according to another non-limiting embodiment.

### DETAILED DESCRIPTION OF THE EMBODIMENTS

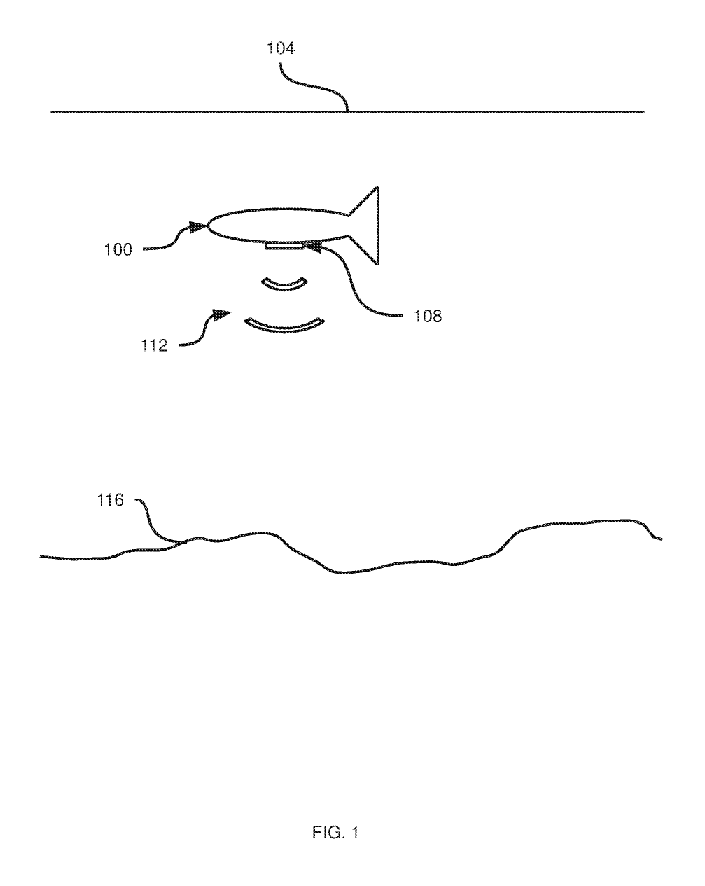

FIG. 1 depicts an underwater vehicle (such as a UUV) 100 below a surface 104 of a body of fluid, typically water. Vehicle 100 includes an acoustic navigation system 108, for example mounted on the hull of vehicle 100. As will be discussed in greater detail below, acoustic navigation system 108 includes a transducer element for emitting acoustic pulses 112 towards a bottom 116 of the body of water (e.g. a seabed), and a plurality of receiver elements for receiving and measuring reflected portions of pulses 112. Vehicle 100 can include additional sensors, such as an inertial navigation system (not shown).

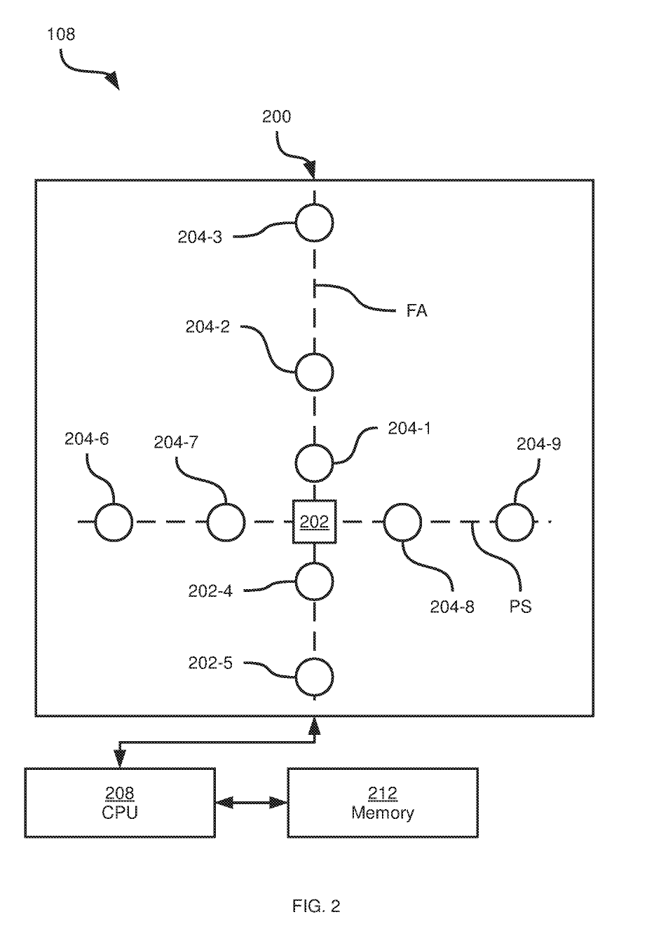

Referring to FIG. 2, system 108 includes an acoustic array 200 comprising a transducer element 202 configured to emit pulses 112 (which may also be referred to as “pings”), and a receiver array including a plurality of acoustic receiver elements 204. Transducer 202 and receivers 204 can be selected from any of a wide variety of conventional sonar transducers and receivers, based on the desired operational characteristics of system 108 (e.g. range and accuracy of velocity measurements). In the example shown in FIG. 2, receivers 204-1, 204-2, 204-3, 204-4, 204-5, 204-6, 204-7, 204-8 and 204-9 are illustrated, collectively referred to as receivers 204 and generically referred to as a receiver 204. Receivers 204 are each configured to detect and measure the reflected portions of pulses 112, such as portions of pulses 112 reflected back towards system 108 by bottom 116. System 100 also includes a central processing unit (also referred to herein as a processor) 208 interconnected with acoustic array 200 and with a memory 212. Processor 200 and memory 212 include one or more integrated circuits; processor 200 is configured to execute computer-readable instructions stored in memory 212 (which may include any suitable combination of volatile and non-volatile memory) to perform the functions described in greater detail herein. Processor 208 and memory 212 interact with array 200 to control the transmission of pulses 112 from transducer 202, and to receive measurements of reflected portions of pulses 112 from receivers 204.

Processor 208 is configured, based on the reflection measurements from receivers 204, to generate a velocity measurement. As will be discussed below, the velocity measurement can be either or both of the velocity of vehicle 100 relative to bottom 116, and the velocity of vehicle 100 relative to the surrounding body of water.

In the present embodiment, system 108 is a CVL navigation system. CVL systems can employ relatively low frequencies (e.g. 30 to 75 kHz), and generally emit pulses such as pulses 112 substantially vertically (i.e. towards bottom 116), rather than at various angles as in DVL systems. CVL systems are therefore generally better suited to navigation at high altitudes above bottom 116.

For example, CVL systems may provide operational ranges from 30 m to over 300 m. In some embodiments, system 108 can operate at altitudes of over 500 m above the seabed.

Two variations of CVL systems exist: (1) a temporal log searches for the time delay that maximizes the correlation between a predetermined pair of receivers, and (2) a spatial log finds a receiver pair that maximizes the correlation for a predetermined time delay (typically the time interval between successive pulses). In either case, the velocity estimate is found by dividing the known distance between receiver elements by the correlation time delay.

In the present embodiment, system 108 implements a spatial log. Thus, processor 208 is configured to receive echo measurements from each of receivers 204, and to search for a pair (or multiple pairs) of receivers 204 that measured highly correlated echoes at a specific time delay. The detection of a receiver pair with echo measurements taken (for example) 0.5 seconds apart (the echo measurements resulting from pulses emitted by transducer 112 and separated by a predetermined period of 0.5 seconds) that correlate well indicates that a second receiver in the pair received an echo from bottom 116 0.5 seconds after the first receiver in the pair received a similar echo. This in turn indicates that when they received their respective echoes, each of the two receivers 204 were in about the same position relative to bottom 116. Employing the known vector (distance and direction; this may be stored in memory 212 for each possible pair of receivers 204, in the form of individual vectors or coordinates for each receiver 204 from which vectors may be computed) between the correlated receiver pair and the known time between the correlated pulses, processor 208 determines the velocity of vehicle 100.

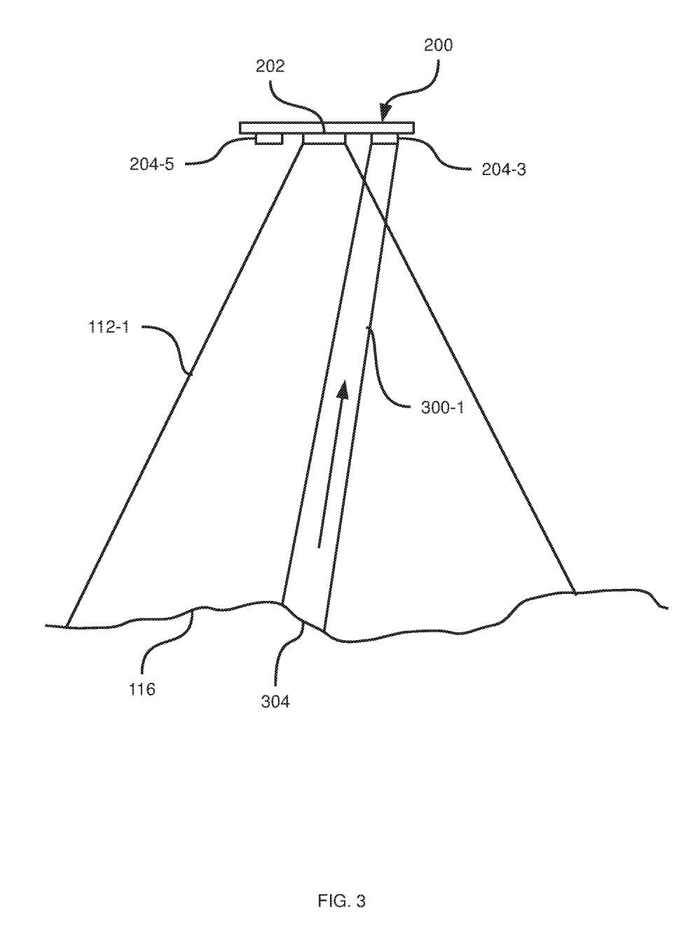

FIGS. 3 and 4 provide a simplified illustration of the above-mentioned generation of a velocity measurement. In FIG. 3, transducer 202 emits a first pulse 112-1 towards bottom 116. As will now be apparent, some of the energy forming pulse 112-1 is reflected by bottom 116, and some of the reflections impact receivers 204. For example, a reflection 300-1 from a portion 304 of bottom 116 is received by receiver 204-3. Processor 208 thus receives signals from receiver 204-3 representing reflection 300-1, and stores those signals in memory 212. As shown in FIG. 4, after emission of first pulse 112-1, transducer emits a second pulse 112-2 towards bottom 116. During the predetermined time interval between first and second pulses 112-1 and 112-2, vehicle 100 (and therefore array 200) has moved relative to bottom 116. Thus, pulse 112-2 “illuminates” a different area of bottom 116 that overlaps with the area illuminated by pulse 112-1.

As seen in FIG. 4, a second echo 300-2 is reflected from the above-mentioned portion 304 of bottom 116. Echo 300-2, however, is detected by receiver 204-5 rather than receiver 204-3, due to the movement of vehicle 100. Therefore, following the emission of second pulse 112-2, processor 208 receives and stores data from receiver 204-5 representing an echo that correlates highly with the data representing echo 300-2. This indicates that at the time of receipt of echoes from second pulse 112-2, receiver 204-5 is in substantially the same location as receiver 204-3 was at the time of receipt of echoes from first pulse 112-1. Based on the known (e.g. stored in memory 212) displacement vector between receivers 204-3 and 204-5 (which specifies a distance and direction between receivers 204-3 and 204-5), as well as the known time interval between pulses 112-1 and 112-2, processor 208 can determine the velocity of vehicle 100 relative to bottom 116.

A variety of configurations are contemplated for the transducer and receiver array of system 108. In general, the receiver array is planar, such that the receivers are all disposed on a common plane (typically the plane is substantially parallel to bottom 116). As a result, the displacement vectors stored in memory 212 for each pair of receivers are two-dimensional vectors. The configuration of FIG. 2 will be described in greater detail, followed by descriptions of other example array configurations. In general, the receiver array of system 108 includes a plurality of neighbouring pairs of receivers. As used herein, the term “neighbouring pair” indicates any given receiver and the closest receiver to it by distance (in any direction). Further, in the various receiver arrays that are contemplated herein, a distance between a first neighbouring pair is different from a distance between a second neighbouring pair. In other words, the receivers are irregularly spaced.

Returning to FIG. 2, transducer 202 is shown as being disposed near the center of receivers 204 (that is, where two axes of receivers 204 intersect). However, in other embodiments transducer 202 may be located at any other suitable location in array 200. In the embodiments discussed herein, the transducer and receivers are mounted on a common base plate; however, in other embodiments, they may be supported by any suitable number of mounting structures.

In the example shown in FIG. 2, receivers 204 are arranged along two axes: a fore-aft axis FA that is parallel to the forward and rearward directions of motion of vehicle 100 and a second axis PS, perpendicular to the first axis, that is parallel to port and starboard motion of vehicle 100. As noted above, along each axis, the distance between pairs of neighbouring receivers 204 is not constant. For example, the distance between receivers 204-1 and 204-2 (which are considered a neighbouring pair because receiver 204-2 is the closest neighbour of receiver 204-1) is smaller than the distance between receivers 204-3 and 204-2 (which are considered another neighbouring pair because receiver 204-2 is the closest neighbour of receiver 204-3). In the example of FIG. 2, the distance between neighbouring receivers 204 is greater for neighbouring receiver pairs located further from the center of array 200 (from transducer 202, in the present example). In other embodiments, however, the distance between neighbouring pairs need not increase towards the edges of array 200. As will be discussed in greater detail below, the arrangement of receivers 204 at varying (i.e. irregular) distances from each other as shown in FIG. 2 reduces the number of redundant displacement vectors between receiver pairs.

As will be apparent from FIG. 2, it is not necessary for every neighbouring pair of receivers 204 to have a different distance separating the pair than the distances separating all other pairs. For example, the distance between receivers 204-6 and 204-7 is equal to the distance between receivers 204-8 and 204-9. In other embodiments, as will be discussed below, however, every neighbouring pair of receivers can be separated by a unique distance. In general, fewer equally-spaced neighbouring pairs of receivers leads to reduced displacement vector redundancy.

As seen in FIG. 2, a greater number of receivers 204 may be arranged along axis FA (e.g. provided corresponding to the forward direction of travel, see receivers 204-1, 204-2 and 204-3), thus providing a greater variety of displacement vectors along axis FA. In other embodiments, greater numbers of sensors may be employed along either axis than that shown in FIG. 2.

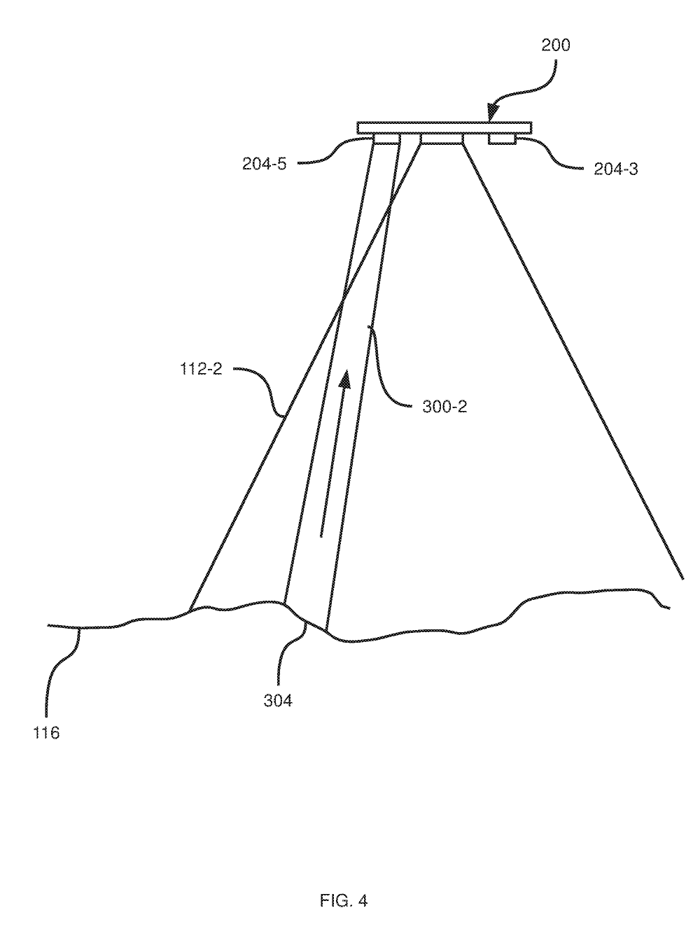

Referring now to FIG. 5, a further example 500 of an array for use in system 108 is depicted. Array 500 includes a transducer 502 which is as described above in connection with transducer 202. Array 500 also includes eight receivers 504-1, 504-2, 504-3, 504-4, 504-5, 504-6, 504-7 and 504-8. Receivers 504 are arranged along axes as shown in FIG. 2, however receivers 504-6, 504-7 and 504-8 are distributed asymmetrically in comparison with the PS-axis receivers of array 200. In other words, receivers 504 of array 500 have fewer pairs of neighbouring receivers 504 with equal distances therebetween.

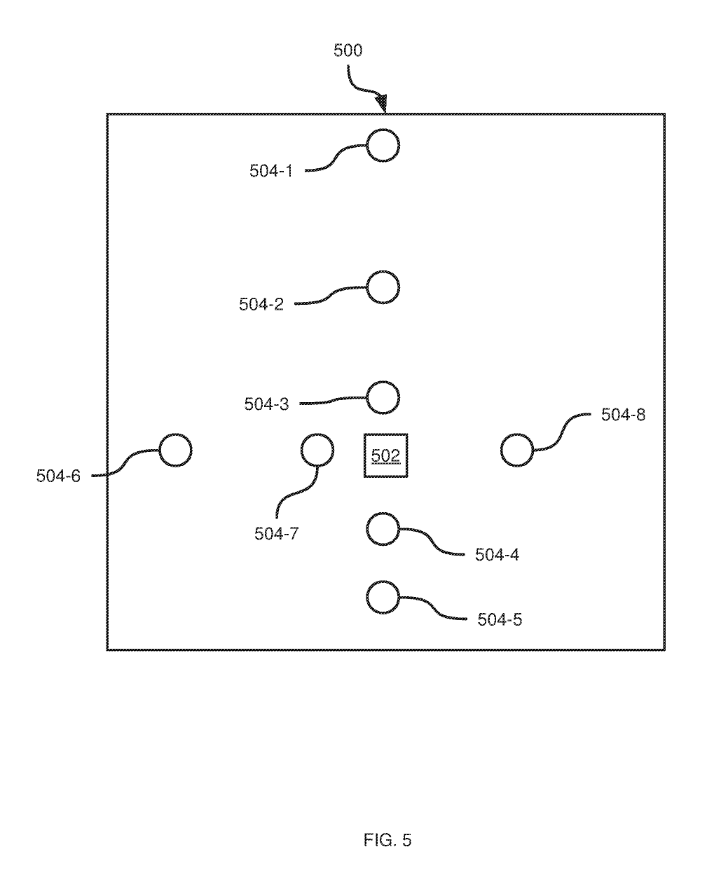

Turning now to FIG. 6, a diagram illustrating the displacement vectors between each possible pair of receivers 504 in array 500 is shown. Vector 600, for example, corresponds to the displacement between receivers 504-8 and 504-6. Data representing each displacement vector may be stored in memory 212 (for example, as a direction and a distance, e.g. 270 degrees from the fore direction, and a distance of 6 cm for vector 600). As seen in FIG. 6, a total of fifty-six unique vectors are illustrated. In other words, every neighbouring pair in array 500 has a different separating distance than every other neighbouring pair, and thus defines a unique displacement vector.

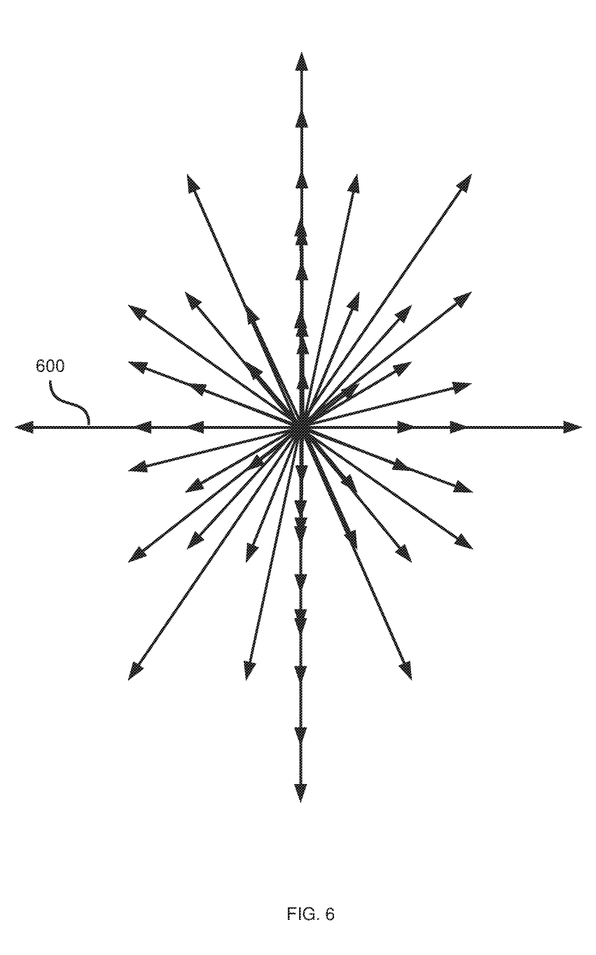

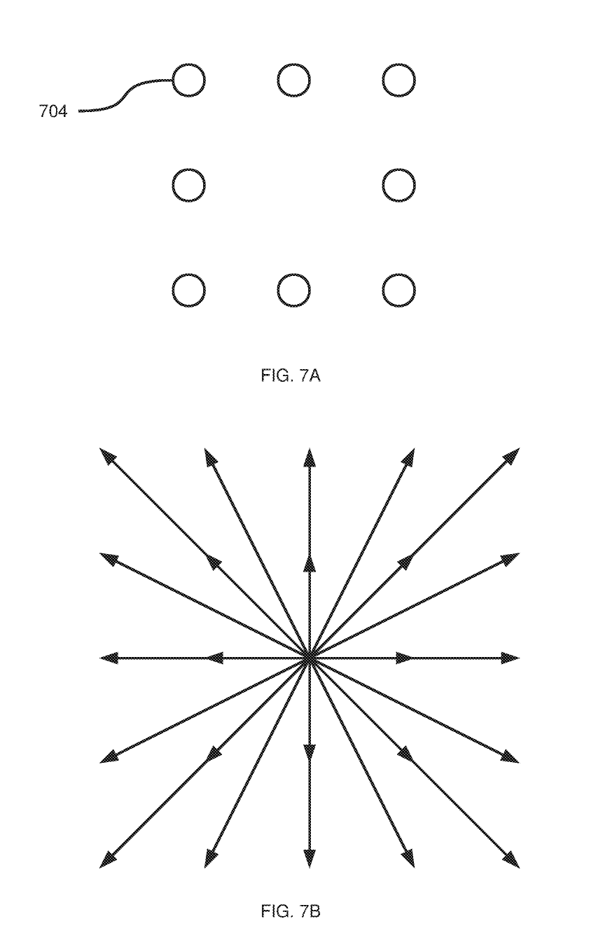

In contrast, FIG. 7A depicts an array of receivers 704 that is not structured in accordance with this specification, as every neighbouring pair of receivers 704 has the same separation distance. FIG. 7B depicts the displacement vector coverage of the array shown in FIG. 7A. As will now be apparent, despite containing the same number of receivers as array 500, the array of FIG. 7A defines only twenty-four unique displacement vectors. Therefore, an array such as that shown in FIG. 7A may not permit the generation of velocity measurements to the same degree of accuracy as array 500.

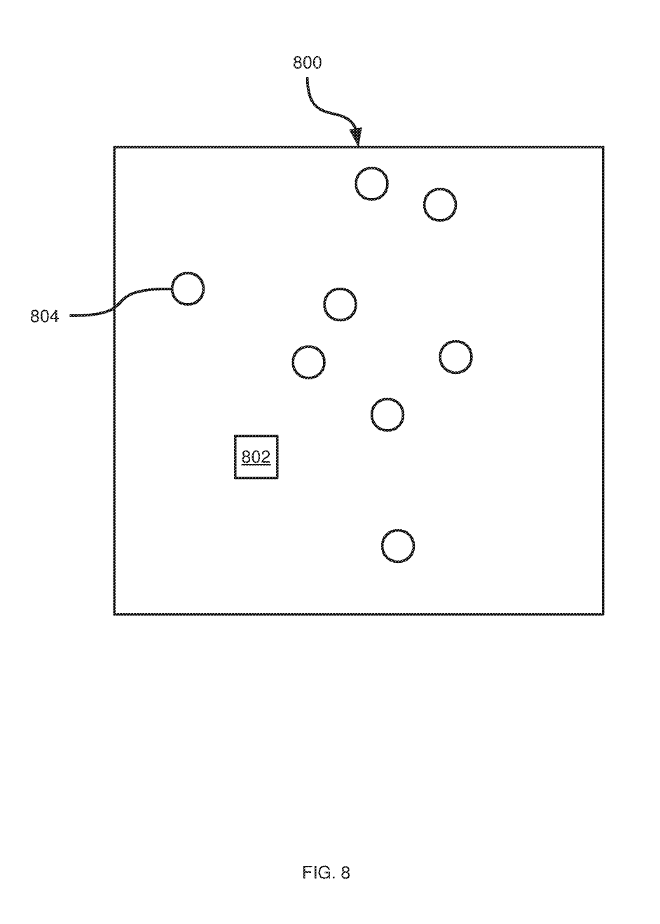

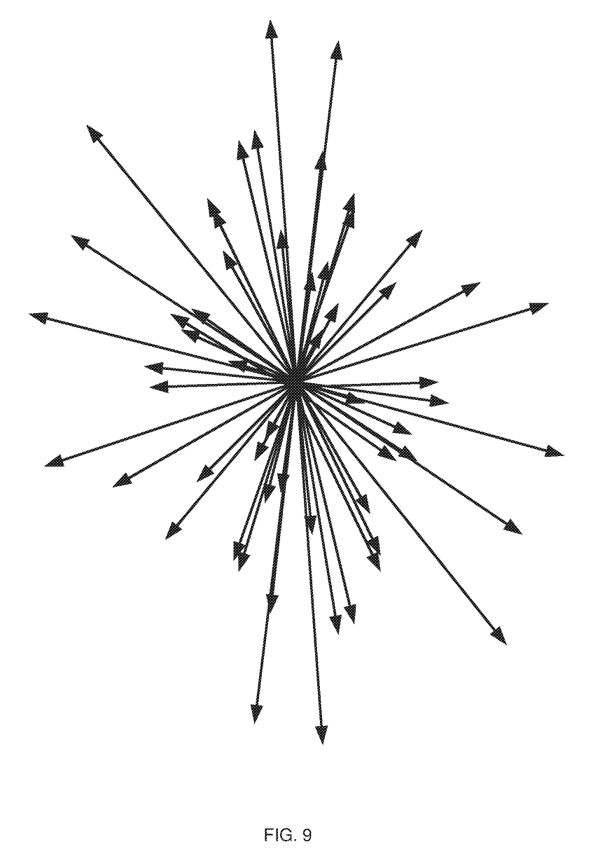

FIG. 8 depicts a further example array 800, including a transducer 802 (as described above in connection with transducer 202) and a plurality of receivers 804. Receivers 804 are not disposed along axes, in contrast with arrays 200 and 500. However, receivers 804 share with receivers 204 and 504 the above-mentioned property of irregular spacing, providing a greater number of displacement vectors which processor 208 can correlate to the movement of vehicle 100. FIG. 9 depicts the displacement vector coverage of the receivers of array 800. As will now be apparent, a wide variety of receiver arrays may be assembled according to the teachings herein, by selecting the positioning of the receivers (and, in particular, by increasing or reducing the number of neighbouring pairs of receivers having the same separation distance) based on the available space for the array and the desired operational characteristics of the array.

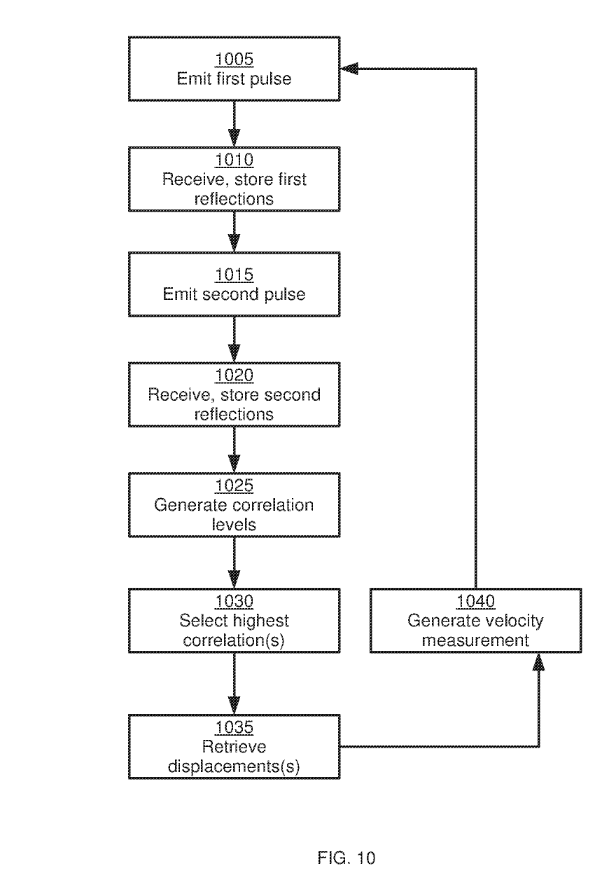

Turning now to FIG. 10, a method 1000 of generating velocity measurements is illustrated. At block 1005, processor 208 is configured to control any of the above-mentioned transducers to emit a first acoustic pulse. At block 1010, processor 208 is configured receive, from each receiver, a first reflected portion of the pulse emitted at block 1005. In some embodiments, processor 208 can also be configured to determine a range of the echoed object from the received reflections, and discard certain reflections. For example, the reflections may be divided into range bins. If method 1000 is being performed to measure the velocity of vehicle 100, only the range bin having the furthest range may be retained, and the remaining reflection data (which may include reflections from the water itself, or other objects in the water above bottom 116) may be discarded.

At blocks 1015 and 1020, the emission of a pulse and receipt of reflections is repeated, as described above. Thus, following the performance of block 1020, memory 212 stores two sets of reflections: a first set including reflection data from each receiver corresponding to echoes of the first pulse, and a second set including reflection data from each receiver corresponding to echoes of the second pulse.

At block 1025, processor 208 is configured, for each receiver, to generate a correlation level between the first reflection from that receiver and the second reflections from all other receivers. The correlation level is an indication (e.g. a value between zero, indicating no correlation, and one, indicating that the reflections are substantially identical) of how similar the compared reflections are.

At block 1030, processor 208 is configured to select the highest correlation level generated at block 1025. In some embodiments, processor 208 can be configured to select multiple correlation levels at block 1030. For example, if there is no single correlation level that is sufficiently high (e.g. that satisfies a preconfigured threshold) or that is sufficiently larger than any other correlation level (again, for example, by a preconfigured threshold), processor 208 can be configured to select a number of the highest correlation levels.

At block 1035, processor 208 is configured to retrieve the displacement vectors (that is, data defining direction and distance, as noted earlier) corresponding to the correlation levels selected at block 1030. For example, if the highest correlation level corresponds to the first reflection from receiver 204-3 and the second reflection from receiver 204-5, then at block 1035 processor 208 is configured to retrieve the displacement vector between receivers 204-3 and 204-5. At block 1040, processor 208 is configured to generate a velocity measurement in the plane of the receiver array based on the displacement vector and the known time interval between the pulses emitted at blocks 1005 and 1015 (e.g. by dividing the displacement vector by the time interval).

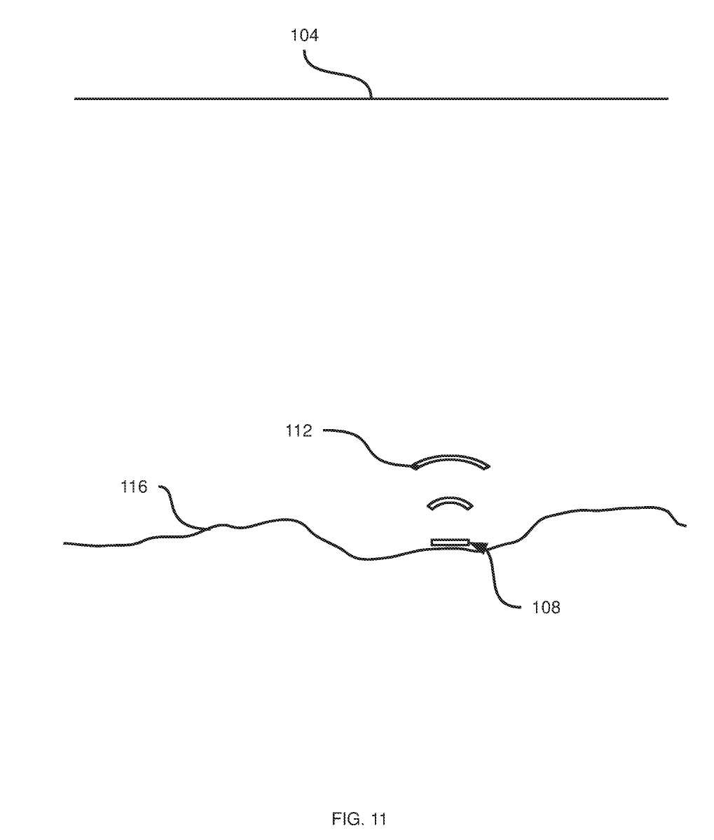

Although system 108 is described above in connection with measuring the velocity of vehicle 100, in other embodiments, system 108 can be placed on bottom 116 of a body of water, rather than on a vehicle. FIG. 11 depicts such an embodiment, in which system 108 is mounted on bottom 116. In other embodiments, system 108 need not be mounted directly to bottom 116. Instead, for example, system 108 can be carried by a structure anchored to bottom 116 (or maintained substantially stationary relative to bottom 116 by any other suitable means) at any desired depth in the body of fluid.

As noted above, reflections detected by the receivers of system 108 include reflections from the body of fluid itself. Thus, the reflections can be used (by performing method 1000) by system 108 to generate velocity measurements for fluid currents. In such embodiments, instead of range binning the reflection data and discarding all but the most distant reflections, one or more intermediate bins of reflection data may be retained for further processing. The measurement of fluid velocity relative to system 108 is referred to as correlation current profiling (CCP).

In still further embodiments, system 108 may be mounted on a vehicle, such as vehicle 100, and may be employed to perform both CVL and CCP functions. For example, a plurality of range bins of reflection data may be retained and processed in parallel by processor 208 to yield velocity measurements for both vehicle 100 relative to bottom 116, and for the fluid surrounding vehicle 100 relative to vehicle 100. In some embodiments, different sets of acoustic pulses may be employed for each function. For example, the transducer can be controlled to emit successive pairs of pulses for velocity measurements relative to bottom 116, and separate successive pairs of pulses for velocity measurements relative to the fluid. This may be desirable when velocity measurements relative to fluid require higher-frequency pulses than velocity measurements relative to bottom 116.

Processor 208 can also be configured to perform additional processing activities, such as filtering out detected correlations that indicate an unrealistic acceleration for vehicle 100. For example, processor 208 can compare computed velocity values to one or more thresholds, and discard any values that indicate a velocity above a threshold, or an acceleration above a threshold.

CVL systems such as those described above can provide various advantages over multi-piston DVL systems. For example, the measurement of velocity in the plane of array 200 (i.e. the horizontal component, in the absence of pitch or roll) does not depend on the speed of sound. By its principle of operation, a CVL measures a two-dimensional displacement vector between two receiver channels (e.g. the signals from receivers 204-1 and 204-2) for successive pulses, so that the corresponding velocity measurement is given simply by the displacement divided by the time interval between pulses, with no need for a speed of sound measurement.

The systems discussed above can provide additional advantages over both DVL and conventional CVL systems. For example, the elimination of redundant vectors between receivers can allow system 108 to be implemented with fewer receivers, without sacrificing accuracy of the resulting velocity measurements.

The scope of the claims should not be limited by the embodiments set forth in the above examples, but should be given the broadest interpretation consistent with the description as a whole.

We claim:

1. An underwater navigation system, comprising:
a transducer configured to emit a first and second acoustic pulses separated by a predetermined time period;
a receiver array comprising a plurality of acoustic receivers each configured to receive first reflected portions of the first acoustic pulses and second reflected portions of the second acoustic pulses; the array including a plurality of neighbouring pairs of acoustic receivers wherein a distance between a first neighbouring pair is different from a distance between a second neighbouring pair; and
a processor coupled to the receiver array, and configured to generate a velocity measurement based on the predetermined time period and signals from the receiver array representing the first and second reflected portions.

2. The underwater navigation system of claim 1, wherein the receiver array is a planar receiver array.

3. The underwater navigation system of claim 2, wherein the receivers are distributed in two dimensions on the planar receiver array.

4. The underwater navigation system of claim 1, wherein the transducer and the receiver array are supported by a common base plate.

5. The underwater navigation system of claim 1, the receiver array including a first plurality of receivers along a first axis and a second plurality of receivers along a second axis.

6. The underwater navigation system of claim 5, wherein the first and second axes are perpendicular.

7. The underwater navigation system of claim 6, the receiver array comprising a greater number of the receivers along the first axis than along the second axis.

8. The underwater navigation system of claim 1, wherein each neighbouring pair of the receivers has a unique distance between the neighbouring pair.

9. The underwater navigation system of claim 1, the processor connected to a memory storing a displacement vector for each receiver pair in the receiver array.

10. The underwater navigation system of claim 9, the processor further configured to generate the velocity measurement by:
for each receiver, generating correlation levels between the first reflection for that receiver and the second reflections for the remaining receivers;
selecting the highest correlation level;
retrieve the displacement vector corresponding to the selected correlation level from the memory; and
generate the velocity measurement based on the retrieved displacement vector and the predetermined time period.

11. The underwater navigation system of claim 10, further comprising a housing containing the transducer and the receiver array.

12. The underwater navigation system of claim 11, the housing configured for mounting on a hull of an underwater vehicle for operation in a body of fluid.

13. The underwater navigation system of claim 12, wherein the velocity measurement corresponds to the velocity of the underwater vehicle relative to a bottom of the body of fluid.

14. The underwater navigation system of claim 11, the housing configured for mounting to an anchored structure in a body of fluid.

15. The underwater navigation system of claim 14, wherein the velocity measurement corresponds to the velocity of a portion of the body of fluid relative to the receiver array.

16. The underwater navigation system of claim 12, the processor further configured to generate a first velocity measurement corresponding to the velocity of a portion of the body of fluid relative to the receiver array, and a second velocity measurement corresponding to the velocity of the underwater vehicle relative to a bottom of the body of fluid.
